(19) United States
(12) Patent Application Publication
(10) Pub. No.: US 2025/0003639 A1
(43) Pub. Date: Jan. 2, 2025

(54) MODULAR INLINER ASSEMBLY FOR A CENTRIFUGAL PARTICLE RECEIVER

(71) Applicant: Heliogen Holdings, Inc., Pasadena, CA (US)

(72) Inventors: Andrew Stephen Oles, Baltimore, MD (US); Apurba Kumar Das, Katy, TX (US); Lars Oliver Kim Amsbeck, Offenberg (DE); Manuel Kaiser, Offenberg (DE)

(21) Appl. No.: 18/751,651

(22) Filed: Jun. 24, 2024

Related U.S. Application Data
(60) Provisional application No. 63/511,576, filed on Jun. 30, 2023.

(51) Int. Cl. F24S 80/60; F24S 20/20; F24S 80/00; F28D 13/00; F28F 5/02

(52) U.S. Cl. CPC F24S 80/60; F28D 13/00; F28F 5/02; F24S 20/20; F24S 2080/01

(57) ABSTRACT

A modular inliner assembly can be used in a centrifugal particle receiver to facilitate the formation of a particle film. The modular inliner assembly may include a plurality of inliner tiles coupled to a rotating shell of the centrifugal particle receiver. Each inliner tile may include an inliner panel and a spacer extending from the inliner panel to the shell. An insulation module may be disposed between the inliner panels and the shell. A protection module may be disposed between the inliner panel and the insulation module to reduce wear of the insulation module. The top surface of each inliner panel can include surface features such as recessed slots. Two opposing ends of the inliner panel may include non-linear edges. The non-linear edge pattern on each of the two opposing ends may be different. A consistent gap between inliner panels can be maintained between the non-linear edges.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present disclosure is directed to a particle receiver, and more particularly to a modular inliner for a centrifugal particle receiver for heating particles that pass through the receiver using solar energy and thereafter storing or using the heated particles (e.g., to provide heat for industrial purposes).

### Description of the Related Art

Conventional solar energy systems utilize solar panels to convert sunlight into electricity. However, conventional solar energy systems have various drawbacks that make them inefficient and ineffective for capturing energy from the sun and using it for large energy intensive industries. As an alternative to solar panel based solar energy systems, concentrated solar power (CSP) systems have been developed for applications in various energy intensive industrial processes. Many of these CSP systems rely on particles as a heat transfer medium for converting solar energy into thermal energy. In such CSP systems, a centrifugal particle receiver is commonly utilized to heat the particles with concentrated sunlight. Existing centrifugal particle receivers use a monolithic inliner (one large sheet) that is complex and expensive to manufacture. Further, such receivers are difficult, time consuming and expensive to maintain and often require the removal of the entire receiver (e.g. inliner and surrounding outer shell or drum) for maintenance or replacement of the inliner.

### SUMMARY

The systems, methods, and devices described herein have innovative aspects, no single one of which is indispensable or solely responsible for their desirable attributes. Without limiting the scope of the claims, some of the advantageous features will now be summarized.

The present disclosure provides, among other things, a modular inliner assembly for a centrifugal particle receiver having a rotating shell. The modular inliner assembly includes a plurality of inliner tiles removably coupled to the rotating shell an insulation module disposed between the inliner panels and the rotating shell. Each of the plurality of inliner tiles includes an inliner panel having a top surface extending substantially parallel to the rotating shell and a spacer extending from the inliner panel to the rotating shell. The spacer is configured to space the inliner panel from the rotating shell. The spacer is configured to couple the inliner panel to the rotating shell. The insulation module is configured to inhibit heat transfer from the inliner panels to the rotating shell. The plurality of inliner tiles are spaced from each other by one or more gaps.

In some aspects, the modular inliner assembly further includes a protection module disposed between the inliner panels and the insulation module, wherein the protection module is configured to span across the one or more gaps and provide wear protection to the insulation module.

In some aspects, the protection module includes at least one of a metal foil, a metal mesh, or a ceramic cloth.

In some aspects, each of the plurality of inliner panels has a width between about 100 mm and about 300 mm, and the insulation module has a thickness of about 100 mm.

In some aspects, the insulation module includes: a first insulation module disposed adjacent to the rotating shell and a second insulation module disposed adjacent to the first insulation module, wherein the second insulation module is made from a different material than the first insulation module.

In some aspects, the insulation module includes an elastic insulation material.

In some aspects, each of the plurality of inliner panels includes angled sides configured to prevent particles from becoming stuck between adjacent inliner panels.

In some aspects, the one or more gaps are configured to allow thermal expansion of the plurality of inliner panels.

In some aspects, the gap has a minimum width of about five particle diameters after the plurality of inliner panels have thermally expanded.

In some aspects, each of the plurality of inliner tiles further includes a spring spacer extending between and connecting adjacent inliner panels, wherein the spring spacer is configured to cover the one or more gaps between adjacent inliner panels, wherein the spring spacer forms a recessed channel extending between adjacent inliner panels.

In some aspects, each of the plurality of inliner tiles further includes a shelf extending between adjacent inliner panels, wherein the shelf is configured to cover the one or more gaps between adjacent inliner panels, wherein the shelf forms a recessed channel extending between adjacent inliner panels.

In some aspects, the shelf is spaced by a shelf gap from an underside of an adjacent inliner tile, wherein the shelf gap is configured to allow the shelf to slide relative to the adjacent inliner panel during thermal expansion of the plurality of inliner tiles.

In some aspects, each of the plurality of inliner tiles further includes a roller disposed between the shelf and the underside of the adjacent inliner tile.

In some aspects, the shelf is mechanically fastened to an adjacent inliner panel.

In some aspects, the plurality of inliner tiles extend circumferentially around the rotating shell such that the top surfaces of each of the plurality of inliner tiles collectively form a substantially annular surface that is concentric with the rotating shell.

In other aspects, the present disclosure provides an inliner tile for a centrifugal particle receiver having a rotating shell. The inliner tile includes an inliner panel having a top surface extending substantially parallel to the rotating shell, wherein the top surface includes a plurality of recessed slots configured to retain particles on the top surface of the inliner panel or a plurality of protrusions configured to retain particles on the top surface of the inliner panel, and a spacer extending from the inliner panel to the rotating shell, wherein the spacer is configured to space the inliner panel from the rotating shell. The spacer is configured to couple to the inliner panel to the rotating shell.

In some aspects, each of the plurality of recessed slots has a size of about five to seven times a particle diameter and a depth of about one to five times the particle diameter.

In other aspects, the present disclosure provides an inliner tile for a centrifugal particle receiver having a rotating shell. The inliner tile includes an inliner panel and a spacer extending from the inliner panel to the rotating shell. The inliner panel includes a top surface extending substantially parallel to the rotating shell and two opposite ends extending in a substantially axial direction of the rotating shell, wherein each of the two opposite ends includes a non-linear edge configured to key into a corresponding non-linear edge of an adjacent inliner panel. The spacer is configured to space the inliner panel from the rotating shell. The spacer is configured to couple to the inliner panel to the rotating shell.

In some aspects, a substantially consistent gap is maintained between the non-linear edge of the inliner tile and the non-linear edge of the adjacent inliner tile.

In some aspects, the non-linear edge is formed by a plurality of V-shaped features to define a tooth-like edge.

In some aspects, the non-linear edge is formed by a plurality of wave-like features to define a wave-like edge.

In some aspects, one of the two opposite ends includes a non-linear edge formed by a repeating pattern of a short peak disposed adjacent to a long valley, wherein the other one of the two opposite ends includes a non-linear edge formed by a repeating pattern of a short valley disposed adjacent to a long peak, wherein the short peak is configured to key into a corresponding short valley of the adjacent inliner tile and the long valley is configured to key into a corresponding long peak of the adjacent inliner tile such that a substantially consistent gap is maintained between the inliner tile and the adjacent inliner tile

### BRIEF DESCRIPTION OF THE DRAWINGS

Non-limiting features of some embodiments of the inventions are set forth with particularity in the claims that follow. The following drawings are for illustrative purposes only and show non-limiting embodiments. Features from different figures may be combined in several embodiments. It should be understood that the figures are not necessarily drawn to scale. Distances, angles, etc. are merely illustrative and do not necessarily bear an exact relationship to actual dimensions and layout of the devices illustrated.

FIG. 1 depicts a schematic view of a concentrated solar power system.

FIG. 2 depicts a schematic view of a receiver system that can be used in the concentrated solar power system of FIG. 1.

FIG. 3 depicts a schematic partial cross-sectional view of a first embodiment of a modular inliner assembly for a centrifugal particle receiver.

FIG. 4 depicts a schematic partial cross-sectional view of a second embodiment of a modular inliner assembly for a centrifugal particle receiver.

FIG. 5 depicts a schematic partial cross-sectional view of a third embodiment of a modular inliner assembly for a centrifugal particle receiver.

FIG. 6 depicts a schematic partial cross-sectional view of a fourth embodiment of a modular inliner assembly for a centrifugal particle receiver.

FIG. 7 depicts a schematic partial cross-sectional view of a fifth embodiment of a modular inliner assembly for a centrifugal particle receiver.

FIG. 8A depicts a schematic partial cross-sectional view of a sixth embodiment of a modular inliner assembly for a centrifugal particle receiver.

FIG. 8B depicts a schematic partial cross-sectional view of a seventh embodiment of a modular inliner assembly for a centrifugal particle receiver.

FIG. 9A depicts a schematic partial cross-sectional view of an eighth embodiment of a modular inliner assembly for a centrifugal particle receiver.

FIG. 9B depicts a perspective view of a portion of the modular inliner assembly of FIG. 9A.

FIG. 10 depict a schematic transverse cross-sectional view of a modular inliner assembly in an assembled configuration.

FIG. 11A depicts a bottom perspective view of inliner tiles attached to a shell.

FIG. 11B depicts a top perspective view of the inliner tiles and shell of FIG. 11A.

FIG. 11C depicts a bottom perspective view of an inliner tile of FIGS. 11A-11B.

FIG. 12A depicts a top view of an inliner panel with surface features according to a first embodiment.

FIG. 12B depicts a side view of the inliner panel of FIG. 12A.

FIG. 13 depicts a top view of an inliner panel with surface features according to a second embodiment.

FIG. 14A depicts a top view of an inliner panel with surface features according to a third embodiment.

FIG. 14B depicts a bottom view of the inliner panel of FIG. 14A.

FIG. 14C depicts a side view of a modular inliner assembly with the inliner panels of FIG. 14A-14B.

FIG. 15 depicts an inliner panel with non-linear edges according to a first embodiment.

FIG. 16A depicts an inliner panel with non-linear edges according to a second embodiment.

FIG. 16B depicts a plurality of the inliner tiles of FIG. 16A disposed adjacent each other so that their non-linear edges are keyed together.

FIG. 17A depicts an inliner panel with non-linear edges according to a third embodiment.

FIG. 17B depicts a bottom perspective view of the inliner tile of FIG. 17A with an attached spacer.

FIG. 17C depicts a plurality of the inliner tiles of FIG. 17A disposed adjacent each other so that their non-linear edges are keyed together.

### DETAILED DESCRIPTION

While the present description sets forth specific details of various embodiments, it will be appreciated that the description is illustrative only and should not be construed in any way as limiting. Furthermore, various applications of such embodiments and modifications thereto, which may occur to those who are skilled in the art, are also encompassed by the general concepts described herein. Each and every feature described herein, and each and every combination of two or more of such features, is included within the scope of the present invention provided that the features included in such a combination are not mutually inconsistent.

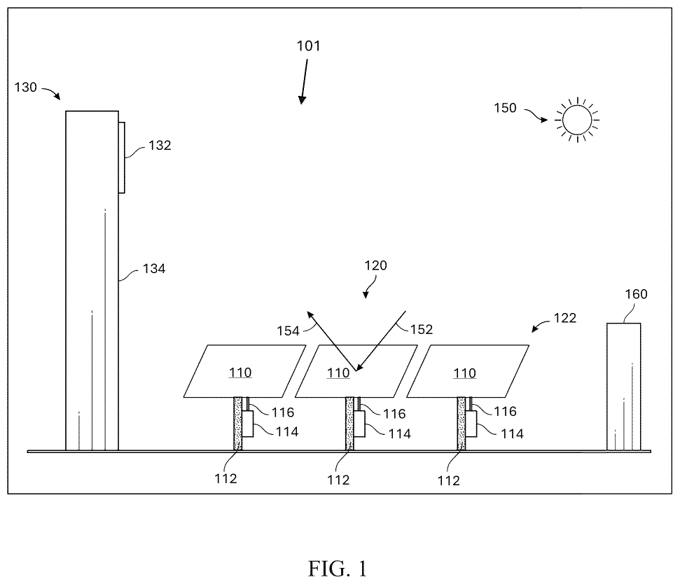

FIGS. 1-17C depict various aspects of a concentrated solar power (CSP) system 101. FIG. 1 depicts a schematic view of an example CSP system 101. The CSP system 101 can include a receiving unit 130, a heliostat array 120, and a power controller 160. The receiving unit 130 can include a receiver system 132 positioned at the top of a tower 134. The heliostat array 120 can include one or more heliostats 122. The heliostats 122 can be supported on shafts or stanchions 112 disposed on or affixed to the ground and/or other heliostats 122. Each heliostat 122 can include a tracking controller 114, an actuator 116, and a mirror 110.

The mirrors 110 can receive incoming sunlight 152 from the sun 150 and direct reflected sunlight 154 to the receiver system 132. The tracking controllers 114 can determine the proper orientation of the mirrors 110 throughout the day to maximize the amount of reflected sunlight 154. The power controller 160 can control the heliostat field (e.g., control the orientation of the heliostats) to direct the reflected sunlight 154 to the receiver system 132 throughout the day. The power controller 160 can provide power to each of the tracking controllers 114 and/or actuators 116 that aim the associated mirror 110.

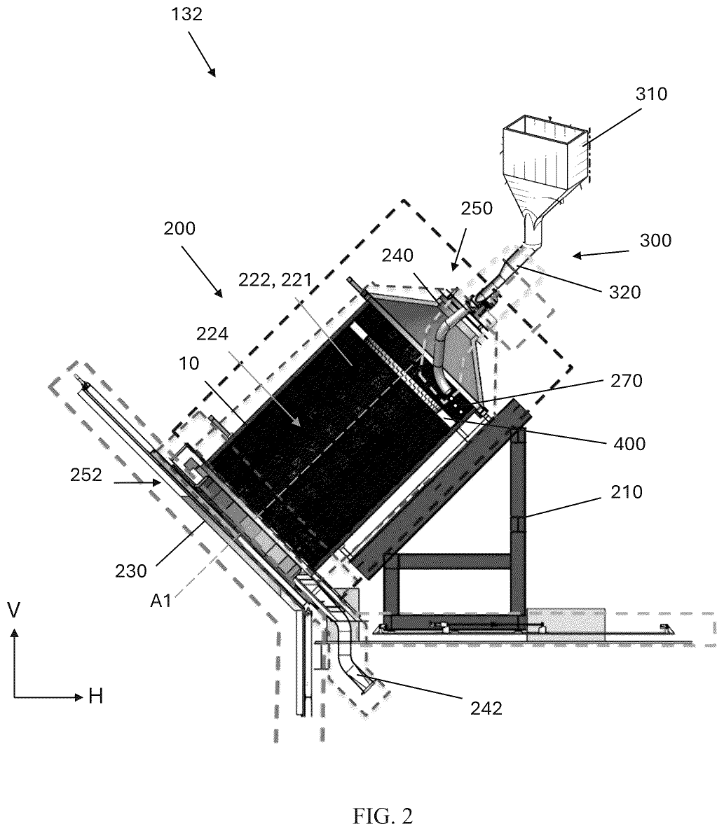

FIG. 2 depicts a schematic view of a receiver system 132 that can be used in the CSP system 101 shown in FIG. 1. The receiver system 132 can be located at an elevated position (e.g., on a roof of a building or on top of a tower 134). The receiver system 132 can be exposed to sunlight (e.g., reflected sunlight 154) directed from the mirrors 110 positioned below the receiver system 132. The receiver system 132 can utilize the reflected sunlight 154 to heat particles 270 conveyed through the receiver system 132. In some embodiments, the receiver system 132 can heat the particles 270 to about 1100° C. In some embodiments, the particles 270 can be made of ceramic materials, inorganic materials, or other materials (e.g., sand, coated sand, bauxite, sintered bauxite, silica, alumina, iron, carbo-ceramic, etc.). In some embodiments, the particles 270 can be substantially ball-shaped. In some embodiments, the particles 270 can have a size (e.g., diameter) between about 10 μm to about 1000 μm, or any range contained therein (e.g., 10-50 μm, 40-50 μm, 200-400 μm, 10-500 μm, etc.). In some embodiments, the particles 270 can be fluidized (e.g., caused to flow like a fluid) with air, where an airflow stream carries particles 270 to the receiver 200 as the particles 270 travel through the receiver system 132. After being heated, the particles 270 can be transferred out of the receiver system 132 to a thermal energy storage. The heated particles 270 can be used for one or more industrial processes (e.g., generate electricity, generate steam, facilitate calcination, facilitate a chemical process, etc.).

Referring to FIG. 2, the receiver system 132 can include a receiver 200 (e.g., centrifugal particle receiver or centrifugal solar receiver) and a particle feed system 300. The receiver 200 can facilitate the heating of the particles 270 with reflected sunlight 154. In the illustrated implementation, the receiver 200 is a centrifugal receiver. The receiver 200 can include a frame 210, a shell 10, a particle inlet 240, a particle outlet 242, and a solar aperture 230. A plurality of particles 270 can enter the receiver 200 via the particle inlet 240. The particles 270 can be deposited into the shell 10 by the particle feed system 300. The shell 10 can receive solar flux (e.g., reflected sunlight 154) directed through the solar aperture 230 that heats the particles 270 as the shell 10 is rotated (e.g., as the particles 270 are rotated). After being heated, the particles 270 can exit the receiver 200 via the particle outlet 242 (e.g., and be directed to a storage location).

As shown in FIG. 2 the receiver 200 can be supported by a frame 210. The frame 210 can function as a structure upon which other components of the receiver 200 can be attached. The frame 210 can support the shell 10. The shell 10 can be a drum. The shell 10 can be a rotating shell (e.g., rotating drum). The shell 10 can house and rotate particles 270 as they are heated by reflected sunlight 154. The shell 10 can be rotatably coupled to the frame 210. The shell 10 can rotate with respect to the frame 210 while the frame 210 remains stationary. In some embodiments, the shell 10 can rotate at any velocity between about 5 m/s and about 10 m/s. In other embodiments, the shell 10 can rotate below 5 m/s or above 10 m/s. In some embodiments, the shell 10 can rotate at any speed between about 20 rpm and about 70 rpm (e.g., between about 65 rpm and about 70 rpm, between about 30 rpm and about 35 rpm, etc.). In some embodiments, the shell 10 can rotate in the counterclockwise direction. In other embodiments, the shell 10 can rotate in the clockwise direction. The shell 10 can be substantially cylindrical. The shell 10 can include an absorber chamber 224 and an inliner 222. The shell 10 can include a hollow interior defining the absorber chamber 224. The absorber chamber 224 can house the particles 270 as they are heated by reflected sunlight 154. An interior surface 221 of the shell 10 can define an outer boundary of the absorber chamber 224. In some embodiments, the inliner 222 can be disposed on the interior surfaces 221 of the shell 10. The inliner 222 can be a modular inliner assembly 100 including a plurality of inliner tiles 30, as further discussed below. The inliner 222 can be coupled to and extend circumferentially around the interior surface 221 of the shell 10. The inliner 222 can form the interior surface 221 of the shell 10. The inliner 222 can cover all or a significant portion (e.g., 95% or more, 90% or more) of the interior surface 221 of the shell 10. Particles 270 can be deposited onto the inliner 222 to form a particle film 490 on the inliner 222.

As shown in FIG. 2, the receiver 200 can extend from a first end 250 to an opposing second end 252. The particle inlet 240 can be disposed at or proximate the first end 250 of the receiver 200. The particle inlet 240 can be an opening, port, or the like. The particle inlet 240 can interface with the particle feed system 300 to enable particles 270 to be fed into the receiver 200. The particle outlet 242 can be disposed at or proximate the second end 252 of the receiver 200. The particle outlet 242 can be a collection ring, tube, port, or other structure for receiving and/or collecting particles 270. The particles 270 can exit out of the receiver 200 through the particle outlet 242. The solar aperture 230 can be disposed at the second end 252 of the receiver 200. The solar aperture 230 permits reflected sunlight 154 to enter the receiver 200. Reflected sunlight 154 can be directed through the solar aperture 230 into the absorber chamber 224 and onto inliner 222. The solar aperture 230 can be a lens, window, opening, or the like. In some embodiments, all or substantially all surfaces of the inliner 222 can be exposed to sunlight (e.g., as the inliner 222 rotates about the axis Al of the receiver 200).

As shown in FIG. 2, the receiver 200 can be tilted at an inclination angle with respect to the horizontal axis H. In some embodiments, the receiver 200 can be tilted at about 45 degrees from the horizontal axis H. Specifically, the receiver 200 can be tilted such that the particle inlet 240 is disposed above (e.g., vertically spaced from) the solar aperture 230. Particles 270 can be deposited onto the inliner 222 proximal to the first end 250 of the receiver 200. Due to the tilt of the receiver 200, gravitational pull causes the particles 270 to move from the first end 250 to the second end 252 of the receiver 200. The reflected sunlight 154 directed through the solar aperture 230 irradiates the particles 270 as they move from the first end 250 to the second end 252, causing the particles 270 to heat up. Downward motion of the particles 270 can be at least partially counteracted by centrifugal forces caused by rotational motion of the shell 10. Centrifugal forces imparted onto the particles 270 by rotation of the shell 10 can hold the particles 270 against the inliner 222. The rotational speed of the shell 10 can be adjusted to increase or decrease the centrifugal forces imparted onto the particles 270. Accordingly, the rotational speed of the shell 10 can be varied to control the amount of time the particles 270 are exposed to sunlight as they travel from the first end 250 to the second end 252 of the receiver 200. Controlling the exposure time enables control of the particle temperature. After moving from the first end 250 to the second end 252, the particles 270 can exit from or be collected at the particle outlet 242.

The particle feed system 300 can function to accelerate and feed particles 270 into the receiver 200. As shown in FIG. 2, the particle feed system 300 can include a hopper 310 and one or more feedpipes 320. The particle feed system 300 can be disposed at least partially above (e.g., vertically spaced from) the receiver 200 along the vertical axis V such that the force of gravity accelerates particles 270 downwards and into the receiver 200. The hopper 310 can function as a storage chamber for holding particles 270 before they are fed into the receiver 200. The hopper 310 can be a container, chamber, receptacle, or other structure capable of holding a volume of particles 270. The hopper 310 can be controllable to permit or stop the flow of particles 270 out of the hopper 310 and into the one or more feedpipes 320. The hopper 310 can be controllable to vary the flow rate of particles 270 out of the hopper 310.

The one or more feedpipes 320 can transfer particles 270 from the hopper 310 into the receiver 200. The feedpipe 320 can be a tube, chute, pipe, channel, vent, or any other structure capable of conveying particle or fluids. The feedpipe 320 can accelerate particles 270 (under force of gravity) from rest in the hopper 310 and deposit them onto the inliner 222 of the receiver 200. Particles 270 can be conveyed through the feedpipe 320 by gravitational pull. The feedpipe 320 can be coupled to or extend into the particle inlet 240 of the receiver 200. In other embodiments, the particle feed system 300 may not include a feedpipe 320. Rather, in some embodiments, the particle feed system 300 can include any structure or device capable of feeding particles 270 into the receiver 200.

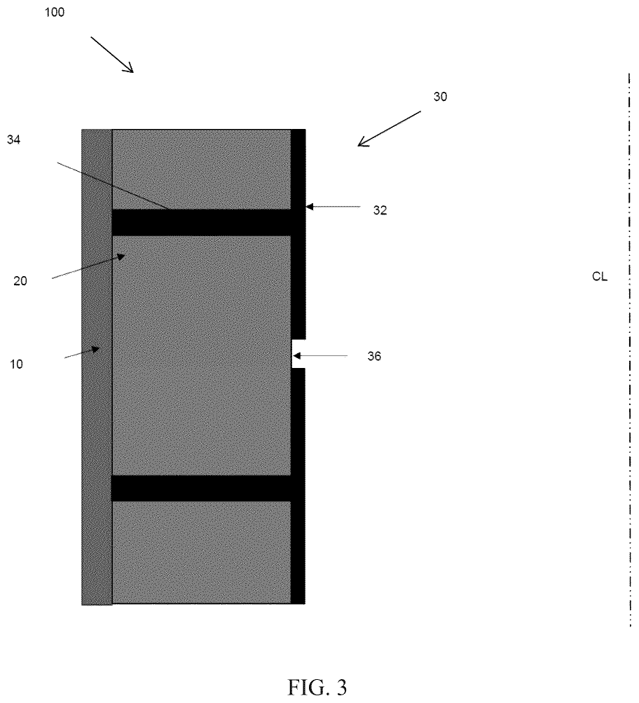

As mentioned above, the inliner 222 can be a modular inliner assembly 100. FIGS. 3-17C depicts various aspects of modular inliner assemblies 100. FIG. 3 is a partial cross-sectional view of a modular inliner assembly 100 (along its length) for a receiver 200 (e.g., centrifugal solar/particle receiver) that extends circumferentially about an axis (a central axis) CL. FIG. 3 shows a portion of the modular inliner assembly 100 on a left side of a center line CL, the right side of the inliner excluded (e.g., but being a mirror image of the left side portion shown in FIG. 3). The modular inliner assembly 100 can rotate relative to an outer housing of the centrifugal solar receiver (e.g., about the center line CL) and can rotate with the drum or shell 10 to which the inliner 222 is coupled. The inliner assembly 100 can include an outer shell 10, a plurality of inliner tiles 30 attached to the shell 10 and an insulation module 20 (e.g., made of wool fiber) disposed between the shell 10 and the inliner tiles 30. Each of the inliner tiles 30 includes a inliner panel 32 and a spacer 34 (e.g., post or holding structure 34) via which the inliner panel 32 couples to the shell 10. In one implementation, the inliner panel 32 is coupled to the post or spacer 34 and the shell 10 via a threaded rod (not shown) that is inserted through the post or spacer 34 and threaded to the shell 10. In another implementation, the inliner panel 32 is integral (e.g., welded) with the spacer 34 and, for example, one or more screws are used to couple the spacer 34 to the shell. Other suitable mechanisms can be used to couple the spacer 34 and/or the inliner panel 32 to the shell 10.

The inliner tiles 30 are coupled to the shell 10 so that the inliner panels 32 are spaced from each other by a gap 36. In one implementation, the gap 36 has a width (e.g., distance between adjacent inliner panels 32) of three or more particle diameters (e.g., 5 or more particle diameters) of the particles 270 that pass through the receiver (e.g., whether the inliner panels 32 are in a thermally expanded state or not), which inhibits particles 270 from being trapped in the gap 36, thus inhibiting (e.g., preventing) jamming or crushing particles 270 between adjacent inliner panels 32 that can result in failure (e.g., warping) of the inliner panel 32. In some embodiments, the gap can have a minimum width of about five particle diameters after the plurality of inliner panels have thermally expanded. Additionally, the sides of the inliner panels 32 can be angled to further inhibit (e.g., prevent) particles 270 from being jammed into the gap 36 between adjacent inliner panels 32. Advantageously, as the inliner panels 32 heat up (e.g., up to between 600° C.-1000° C.), for example due to heat transfer from particles 270 in the receiver, the inliner panels 32 expand (along the length of the receiver) to at least partially fill the gap 36 (e.g., while the insulation module 20 inhibits or minimizes the amount of radial expansion of the shell 10, such as toward the drum of the receiver). The insulation module 20 can inhibit or reduce heat transfer from the inliner panels 32 to the shell 10. Additionally, the inliner assembly 100 advantageously makes maintenance simpler and less time consuming since each inliner tile 30 (e.g., each inliner panel 32) can be separately decoupled from the shell 10 and replaced, for example if it becomes damaged.

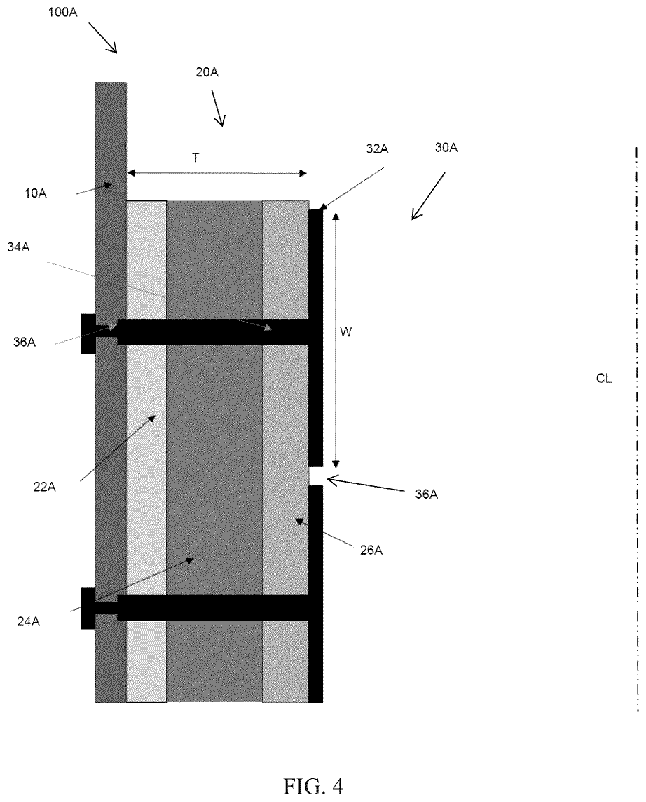

FIG. 4 shows a schematic view of a modular inliner assembly 100A. Some of the features of the modular inliner assembly 100A are similar to features of the modular inliner assembly 100 in FIG. 3. Thus, reference numerals used to designate the various components of the modular inliner assembly 100A are identical to those used for identifying the corresponding components of the modular inliner assembly 100 in FIG. 3, except that an “A” has been added to the numerical identifier. Therefore, the structure and description for the various features of the modular inliner assembly 100 in FIG. 3 and how it's operated are understood to also apply to the corresponding features of the modular inliner assembly 100A in FIG. 4, except as described below.

The modular inliner assembly 100A differs from the modular inliner assembly 100 in that the insulation module 20A includes multiple insulation modules including a first insulation module 22A adjacent the shell 10A, a second insulation module 24A adjacent the first insulation module 22A, and a third insulation module 26A adjacent the second insulation module 24A, where the second insulation module 24A is interposed between the first insulation module 22A and the third insulation module 26A. The third insulation module 26A is adjacent the inliner panels 32A. One or more of the first insulation module 22A (or blanket), second insulation module 24A and third insulation module 26A (or blanket) can be of different material. In one implementation, the first insulation module 22A can be an elastic module (e.g., a glass fiber blanket). In one implementation, the second insulation module 24A can be of a different material than the first insulation module 22A; for example, the second insulation module 24A can be of a microtherm insulation material (e.g., a microporous insulation that is relatively rigid module as compared to the first insulation module 22A). In one implementation, the third insulation module 26A (or blanket) can be of a different material than the second insulation module 24A; for example, the third insulation module 26A can be an elastic high temperature wool (e.g., Altra Mat-72) with a metal foil covering (or ceramic cloth covering). The metal foil covering (or ceramic cloth covering) can advantageously inhibit abrasion of the surface in the gap 36A to inhibit (e.g., prevent) wear of the third insulation module 26A and/or or inhibit (e.g., prevent) ingress of fibers from the third insulation module 26A into the flow of particles 270. Additionally, in one implementation the post 34A and inliner panel 32A of the inliner tile 30 can be integral (e.g., welded together). Alternatively, it could be a single insulation module 20A between the shell 10A and the inliner tiles 32A (e.g., that accommodates compression and expansion of the post 34A, for example caused by thermal expansion).

The post 34A can be integral with the inliner panel 32A (e.g., a T-plate). The post 34A can include a milled rod seat 36A to facilitate coupling the post 34A to the shell 10A. Advantageously, one or more of the first insulation module 22A, second insulation module 24A and third insulation module 26A can expand or compress to accommodate compression or expansion of the post 34A (expansion due to heat). The insulation module 20A can have a thickness T. In one implementation, the thickness T can be about 100 mm. in one implementation, the inliner panel 32A can have a width W. In one implementation the width W can be between about 100 mm and about 300 mm. In one implementation, the inliner panel 32A has a square shape (e.g., has dimensions of about 100 mm×100 mm to about 300 mm×300 mm).

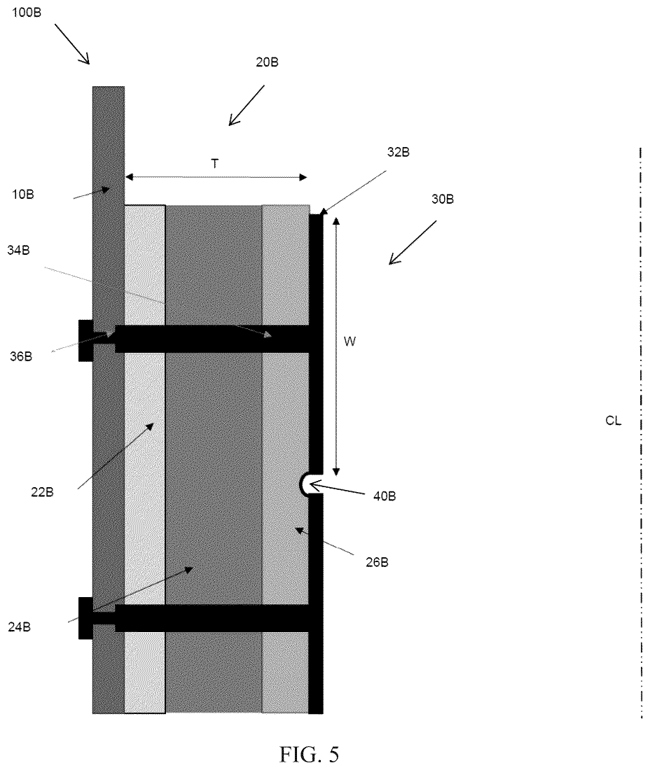

FIG. 5 shows a schematic view of a modular inliner assembly 100B. Some of the features of the modular inliner assembly 100B are similar to features of the modular inliner assembly 100A in FIG. 4. Thus, reference numerals used to designate the various components of the modular inliner assembly 100B are identical to those used for identifying the corresponding components of the modular inliner assembly 100A in FIG. 4, except that a “B” instead of an “A” has been added to the numerical identifier. Therefore, the structure and description for the various features of the modular inliner assembly 100A in FIG. 4 and how it's operated, which are similar to the modular inliner assembly 100 in FIG. 3, are understood to also apply to the corresponding features of the modular inliner assembly 100B in FIG. 5, except as described below.

The modular inliner assembly 100B differs from the modular inliner assembly 100A in that a spring spacer 40B extends between and connects the ends of adjacent inliner panels 32B (e.g., to cover the gap between inliner panels 32B and inhibit or prevent wear of the insulation module 20B (e.g., of the third insulation module 26B). The spring spacer 40B can be made of steel and can flex (e.g., compress, expand) as the inliner panels 32B undergo thermal expansion (e.g., to move toward each other). Alternatively, it could be a single insulation module 20B between the shell 10B and the inliner tiles 32B.

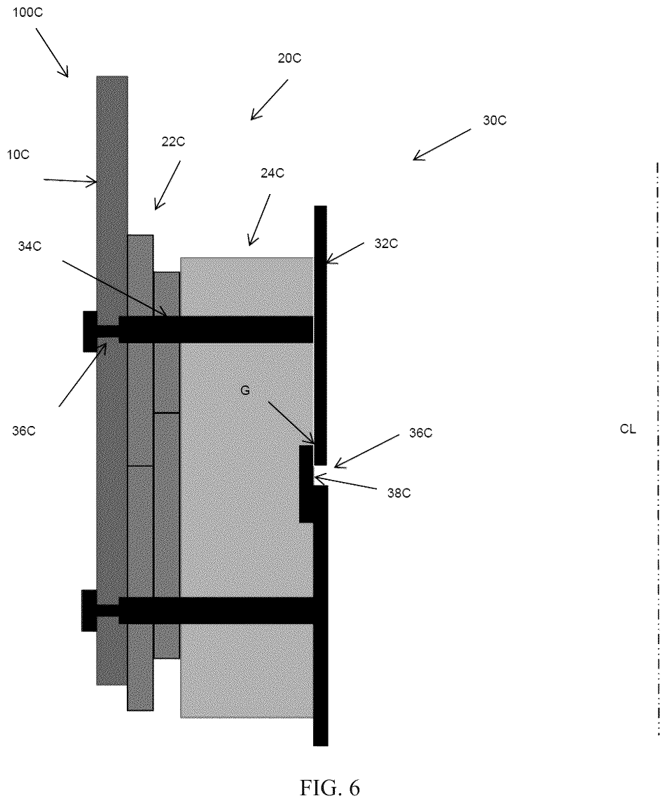

FIG. 6 shows a schematic view of a modular inliner assembly 100C. Some of the features of the modular inliner assembly 100C are similar to features of the modular inliner assembly 100 in FIG. 3. Thus, reference numerals used to designate the various components of the modular inliner assembly 100C are identical to those used for identifying the corresponding components of the modular inliner assembly 100 in FIG. 3, except that a “C” has been added to the numerical identifier. Therefore, the structure and description for the various features of the modular inliner assembly 100 in FIG. 3 and how it's operated are understood to also apply to the corresponding features of the modular inliner assembly 100C in FIG. 6, except as described below.

The modular inliner assembly 100C differs from the modular inliner assembly 100 in that the insulation module 20C includes a first insulation module 22C (e.g., having one or more, such as two, blankets) and a second insulation module 24C between the first insulation module 22C and the inliner panels 32C. Alternatively, it could be a single insulation module 20C between the shell 10C and the inliner tiles 32C. Additionally, the inliner tiles 30C include a shelf or foot 38C that covers the second insulation module 22C (e.g., to inhibit wear of the same by particles 270 that pass into the gap 36C between the inliner panels 32C. The shelf or foot 38C is spaced by a shelf gap G from an underside of an adjacent inliner panel 32C, allowing the sliding of the foot 38C relative to said adjacent inliner panel 32C (e.g., during thermal expansion of the inliner panels 32C).

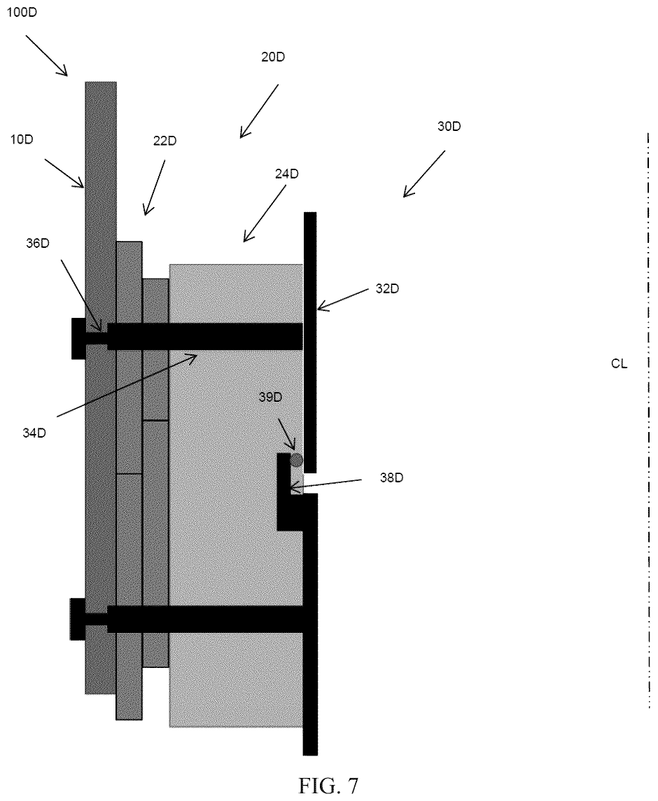

FIG. 7 shows a schematic view of a modular inliner assembly 100D. Some of the features of the modular inliner assembly 100D are similar to features of the modular inliner assembly 100C in FIG. 6. Thus, reference numerals used to designate the various components of the modular inliner assembly 100D are identical to those used for identifying the corresponding components of the modular inliner assembly 100C in FIG. 6, except that a “D” instead of a “C” has been added to the numerical identifier. Therefore, the structure and description for the various features of the modular inliner assembly 100C in FIG. 6 and how it's operated are understood to also apply to the corresponding features of the modular inliner assembly 100D in FIG. 7, except as described below.

The modular inliner assembly 100D differs from the modular inliner assembly 100C in that it includes a roller 39D between the foot 38D and the underside of the inliner panel 32D. The foot 38D covers at least a portion of the insulation module 20D.

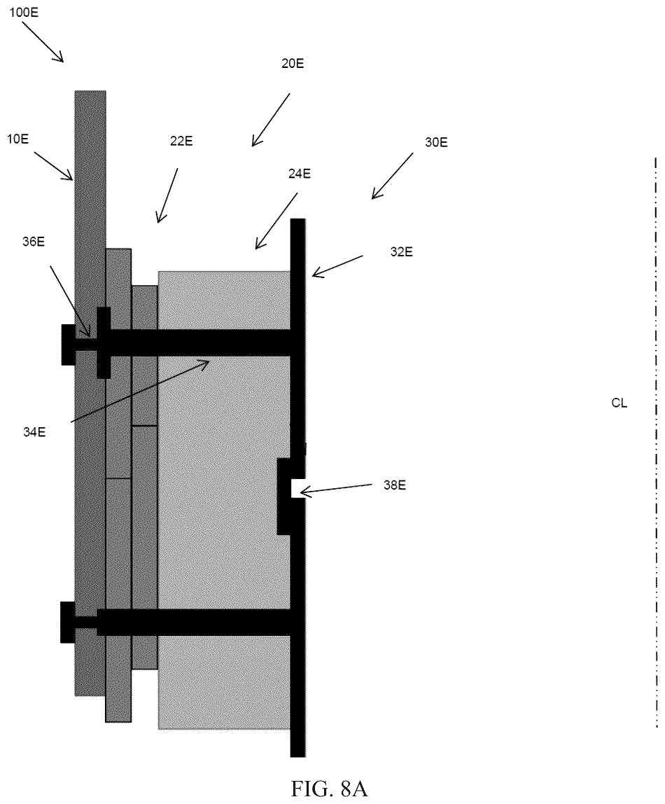

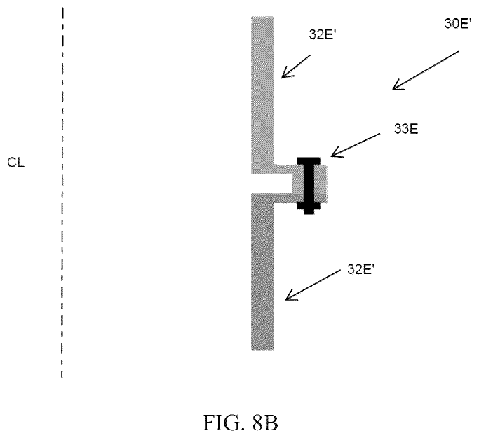

FIG. 8A shows a schematic view of a modular inliner assembly 100E. Some of the features of the modular inliner assembly 100E are similar to features of the modular inliner assembly 100C in FIG. 6. Thus, reference numerals used to designate the various components of the modular inliner assembly 100E are identical to those used for identifying the corresponding components of the modular inliner assembly 100C in FIG. 6, except that an “E” instead of a “C” has been added to the numerical identifier. Therefore, the structure and description for the various features of the modular inliner assembly 100C in FIG. 6 and how it's operated are understood to also apply to the corresponding features of the modular inliner assembly 100E in FIG. 8A, except as described below.

The modular inliner assembly 100E differs from the modular inliner assembly 100C in that the foot 38E extends between adjacent inliner panels 32E without a gap between the foot 38E and the underside of the inliner panels 32E. The foot 38E covers at least a portion of the insulation module 20E.

FIG. 8B shows a partial cross-sectional view of an inliner assembly 100E′ that is a variation of the inliner assembly 100E described above. The inliner assembly 100E′ differs from the inliner assembly 100E in that adjacent inliner panels 32E′ are coupled to each other (e.g., by bolts 33E) and the connection between the inliner panels 32E′ defines the foot 38E′ that covers the insulation module (not shown) between the inliner tiles 30E′ and the shell (not shown). The bolted inliner panels 32E′ can thus form a continuous inliner panel assembly.

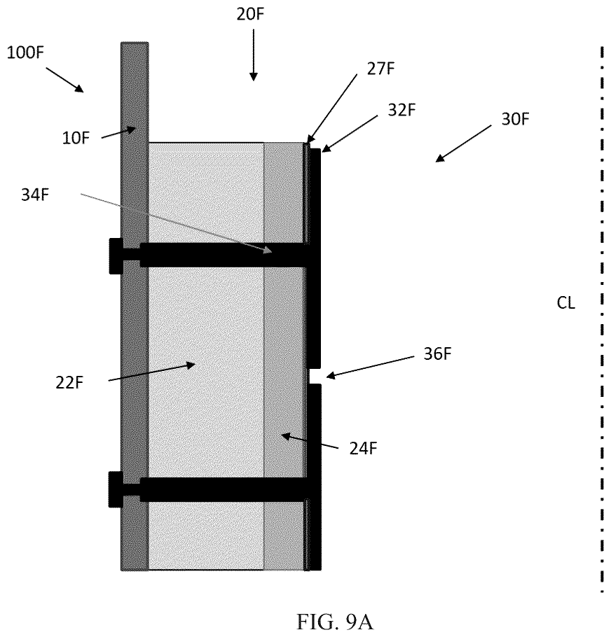

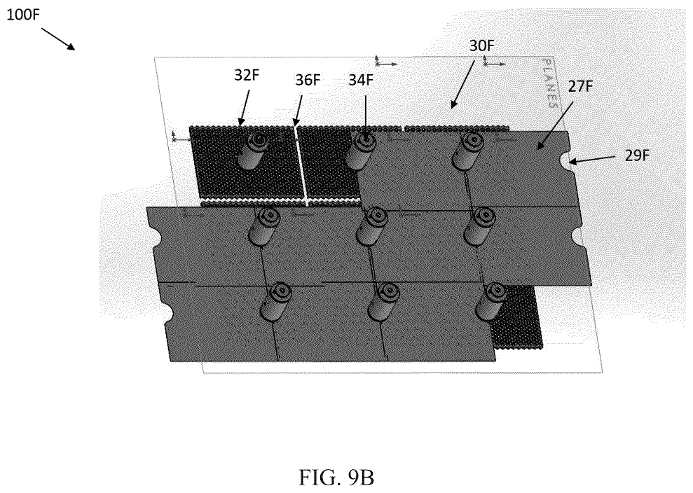

FIG. 9A shows a schematic view of a modular inliner assembly 100F. Some of the features of the modular inliner assembly 100F are similar to features of the modular inliner assembly 100A in FIG. 4. Thus, reference numerals used to designate the various components of the modular inliner assembly 100F are identical to those used for identifying the corresponding components of the modular inliner assembly 100A in FIG. 4, except that an “F” has been added to the numerical identifier. Therefore, the structure and description for the various features of the modular inliner assembly 100 in FIG. 4 and how it's operated are understood to also apply to the corresponding features of the modular inliner assembly 100F in FIG. 9A, except as described below.

The modular inliner assembly 100F differs from the modular inliner assembly 100A in that the insulation module 20F includes a first insulation module 22F disposed adjacent to the shell 10F and a second insulation module 24F disposed adjacent to the first insulation module 22F. In some implementations, the first insulation module 22F can be an elastic material (e.g., a glass fiber blanket). In some implementations, the second insulation module 24F can be of a different material than the first insulation module 22F. For example, the second insulation module 24F can be made from an elastic high temperature insulation wool (e.g., Altra Mat-72). Additionally, the modular inliner assembly 100F can include a protection module 27F (e.g., plate, panel, layer) disposed adjacent to the inliner panel 32F. As shown in FIG. 9A, the second insulation module 24A can be interposed between the first insulation module 22A and the protection module 27F. The protection module 27F can extend between adjacent inliner panels 32F to cover the gap 36F between adjacent inliner panels 32F. The protection module 27F can provide wear protection to the insulation module 20F. Specifically, the protection module 27F can provide wear protection to the second insulation module 24F. Additionally, the protection module 27F can inhibit or prevent ingress of the insulation module 20F (e.g., wool insulation) into the particle film. In some embodiments, the protection module 27F can be a low-gauge plate, mesh, or film. In some embodiments, the protection module 27F can made from metal (e.g., metal foil, stainless steel, Inconel, etc.) or ceramic (e.g., ceramic cloth). In some embodiments, the thickness of the protection plate can be between about 100 to about 400 microns.

FIG. 9B depicts a perspective view of an example modular inliner assembly 100F. The shell 10F and insulation module 20F are not shown in FIG. 9B. As shown in FIG. 9B, the protection module 27F can be formed as a plurality of modular tiles. A plurality of protection modules 27F can be coupled to the underside of a plurality of inliner panels 32F. As shown in FIG. 9B, the protection modules 27F can be fitted together to form a continuous surface on the underside of the inliner panels 32F. Each tile of protection module 27F can cover at least a portion of multiple (e.g., four) inliner panels 32F. Accordingly, the protection module 27F can cover the gaps 36F between adjacent inliner panels 32F. As shown in FIG. 9B, the protection module 27F can include one or more cutouts 29F dimensioned to fit around the post or spacer 34F of each inliner tile 30F.

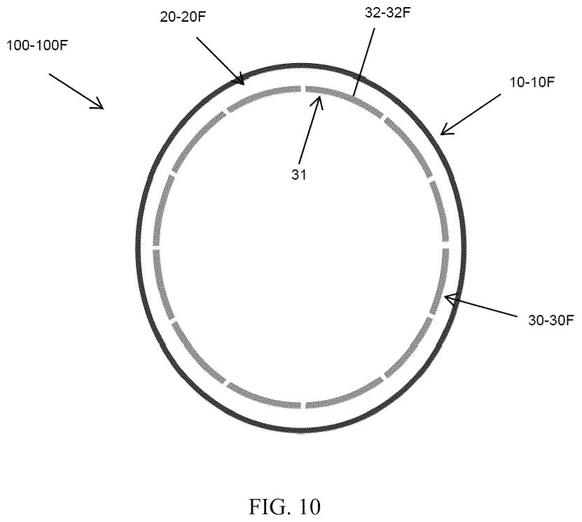

FIG. 10 shows a partial transverse cross-sectional view of the modular inliner assembly 100-100F perpendicular to the central axis CL, showing the outer shell 10-10F, the inliner tiles 30-30F with inliner panels 32-32F and insulation module 20-20F. As shown in FIG. 10, the plurality of inliner tiles 30-30F can extend circumferentially around the rotating shell 10 such that the top surfaces 31 of each of the inliner tiles 30-30F collectively form a substantially annular surface that is concentric with the rotating shell 10.

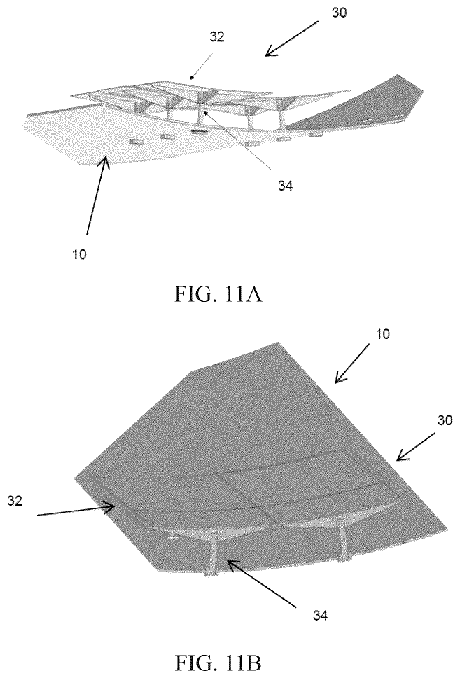

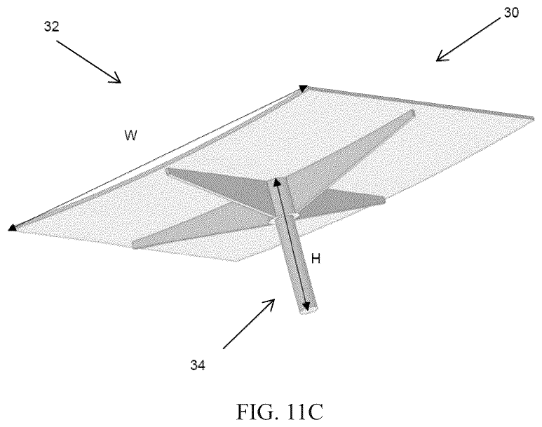

FIGS. 11A-11B show partial views of inliner tiles 30 attached to the shell 10, with the inliner panels 32 of the inliner tiles 30 attached to the shell 10 via posts 34 of the inliner tiles 30, each inliner tile 30 having a single post 34 via which it couples to the shell 10. FIG. 11C shows a single inliner tile 30 having an inliner panel 32 attached to a post 34. The inliner tile can have a width W of about 100-300 mm. In one example, the inliner panel 32 is approximately square (e.g., has dimensions of about 100-300 mm×100-300 mm). However, in other examples, the inliner panel 32 can have other shapes, such as triangular. The post 34 can in some implementations have a height h of about 100-250 mm. In some implementations, the tilt and/or orientation of the inliner tile 30 (e.g., of the inliner panel 32) can be adjustable or varied (e.g., between tiles of the inliner assembly 100). In another implementation, each of the inliner tiles 30 can be directly coupled to the shell 10 by one or more spokes (e.g., four spokes), which insulation disposed between the inliner tiles 30 and the shell 10 (e.g., between the inliner panels 32 and the shell 10). Though FIGS. 11A-11C show inliner tile 30, one of skill in the art will recognize that the inliner tiles 30A-30F can have similar surface features as described above for inliner tile 30 and the inliner panels 32A-32F can have similar features as described above for the inliner panel 32.

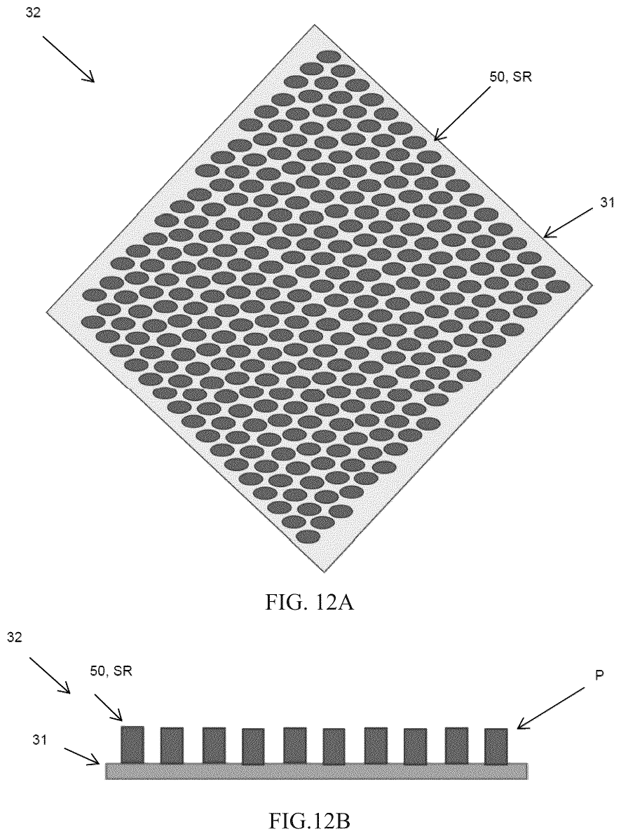

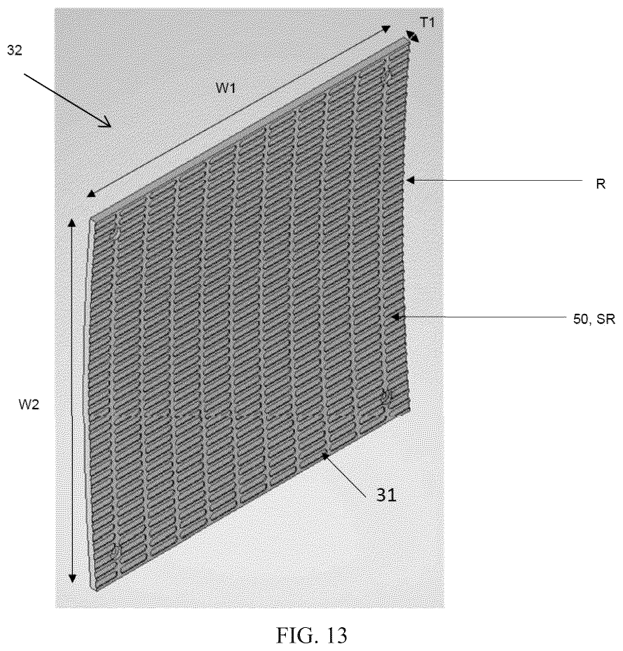

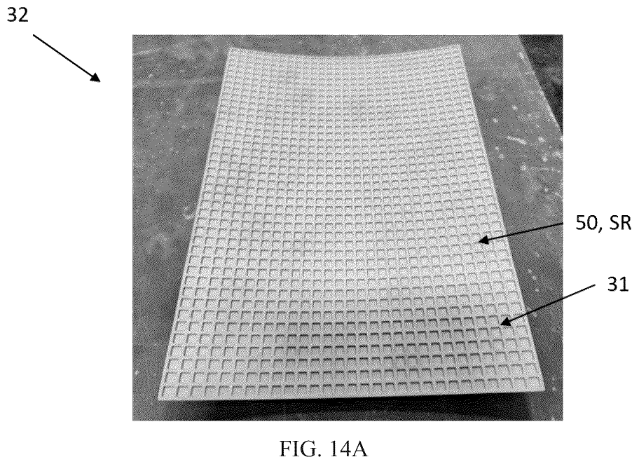

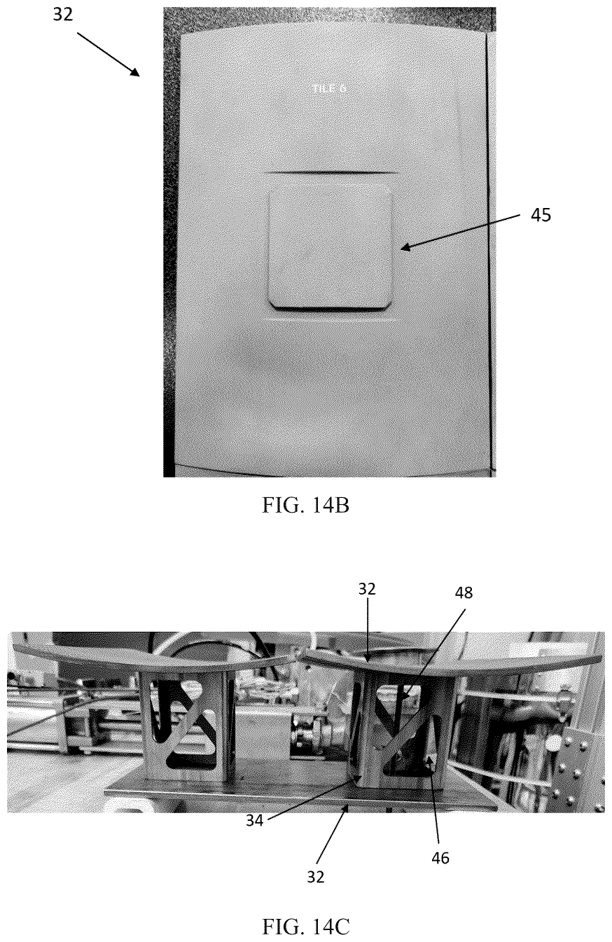

FIG. 12A shows a top view of an inliner panel 32 with a top surface 31 having surface features 50 or surface roughness SR that inhibit (e.g., prevent) rolling of particles 270 on the surface of the inliner panel 32 and facilitate sliding of the particles 270 relative to each other to increase friction between the particles 270 as the drum of the receiver rotates. Such roughness facilitates retaining particles 270 on the surface of the inliner panels 32. FIG. 12B shows a side view of the inliner panel 32 in FIG. 12A and shows the surface features 50 provided by posts P on the top surface 31. In another implementation, such as examples shown in FIGS. 13-14A, the surface features 50 on the inliner panel 32 can instead be holes drilled or slots formed into the panel 32. The inliner panel 32 can have other shaped surface features 50, and such surface features can have different patterns. Though FIGS. 12A-12B show surface features on the inliner panel 32, one of skill in the art will recognize that the inliner panels 32A-32F can have similar surface features as described above for inliner panel 32.

FIG. 13 shows an example inliner panel 32 that is curved (e.g., at a radius R) and has surface roughness SR (e.g., provided by slots formed on a surface of the inliner panel 32). As shown in FIG. 13, the surface roughness SR can be provided by surface features 50 on the top surface 31 of the inliner panel 32. In some embodiments, the surface features 50 can be elongated recessed slots. In some embodiments, the elongated recessed slots extend across a depth (e.g., an entire depth) of the inliner panel 32. As shown in FIG. 13, the recessed slots can be substantially pill-shaped. In some examples, the radius R can be 400-2500 mm. In some examples, the surface roughness SR can be between 400 μm and about 2500 μm. The inliner panel can have dimensions W1×W2. In some examples, the dimensions can be 100-300 mm×100-300 mm. In some examples, the inliner panel 32 can have a generally square perimeter. In some examples, the inliner panel 32 can have a thickness T1 of about 3-10 mm.

FIGS. 14A-14C depict another example inliner panel 32 that is curved and has surface roughness SR (e.g., provided by slots formed on a surface of the inliner panel 32). FIG. 14A shows a top view of the inliner panel 32. As shown in FIG. 14A, the surface features 50 can be substantially square-shaped recessed slots. In some embodiments, the square shaped slots of the inliner panel 32 extend across a depth (e.g., an entire depth) of the inliner panel 32. In other embodiments, the recessed slot can be any other shape (e.g., circles, triangles, etc.). The surface features 50 can be arranged in a grid pattern across the top surface 31 of the inliner panel 32. In some embodiments, the recessed slots can have a size of about 4 mm×4 mm and a depth of about 2 mm. In some embodiments, the size of the recessed slots can be about five to seven times the particle diameter. In some embodiments, the depth of the recessed slots can be about one to two times the particle diameter.

FIG. 14B depicts a bottom view of the inliner panel 32 of FIG. 14A. As shown in FIG. 14B, the inliner panel 32 can include an attachment socket 45. The attachment socket 45 can be disposed on the underside of the inliner panel 32. The attachment socket 45 can be a recessed slot dimensioned to receive a spacer 34 or post. As shown in FIG. 14B, the attachment socket 45 can be formed as a recessed region in the underside of the inliner panel 32. In some embodiments, the attachment socket 45 can be shaped as a square annulus to receive a corresponding square tube spacer (see FIG. 14C).

FIG. 14C depicts a side view of a modular inliner assembly 100 including a plurality of the inliner panels 32 of FIGS. 14A-14B. As shown in FIG. 14C, the post or spacer 34 can be formed as a substantially square tube. The spacer 34 can be coupled to the inliner panel 32 via the attachment socket 45. In some embodiments, the inliner panel 32 and the spacer 34 can be secured to the shell 10 by a threaded rod 48 extending from the shell 10, through the spacer 34, and into a threaded hole in the inliner panel 32 or a nut welded to the underside of the inliner panel 32. In other embodiments, the inliner panel 32 and the spacer 34 can be secured to the shell 10 by other fastening means such as welding, adhesive, or the like. In some embodiments, the spacer 34 can include apertures 46 or cutouts to reduce the volume of material making up the spacer 34. The apertures 46 or cutouts can reduce thermal bridging between the inliner panel 32 and the shell 10, thereby inhibiting (e.g., reducing) thermal stresses on the shell 10. Additionally, portions of the insulation module 20 can be disposed in or through the apertures 46, enabling improved insulation coverage.

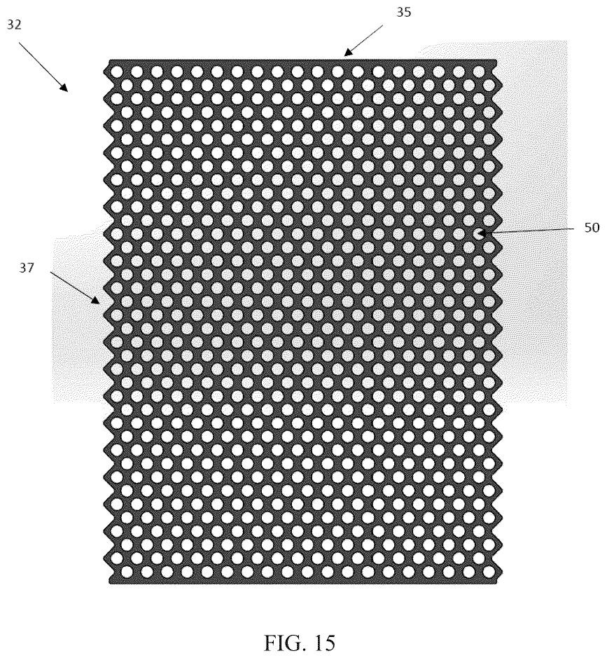

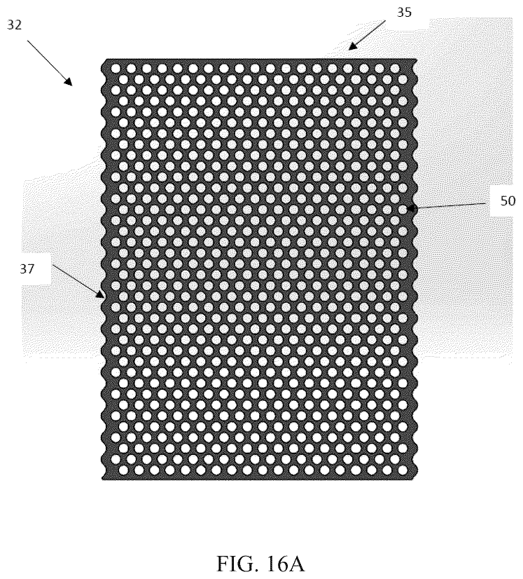

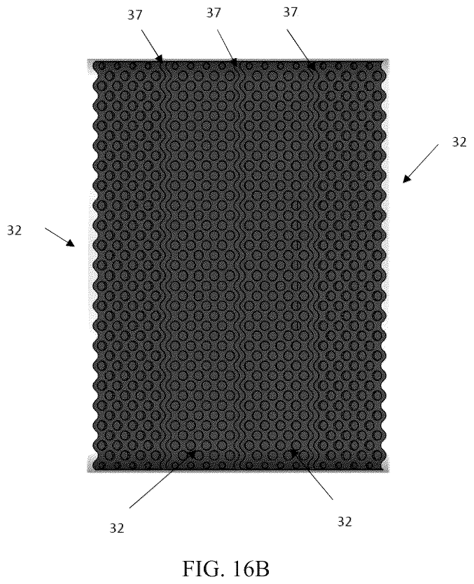

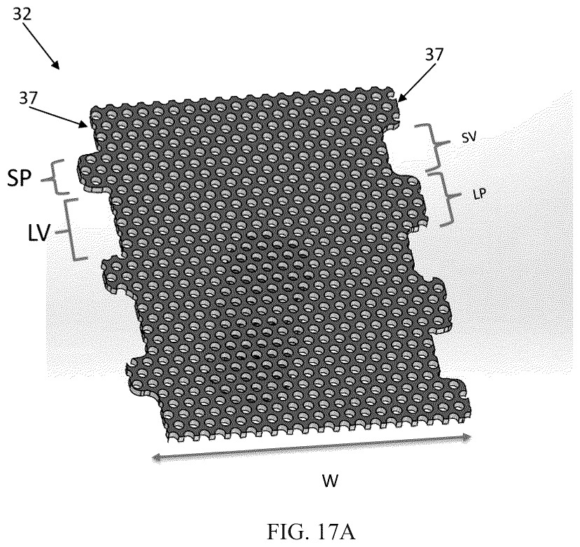

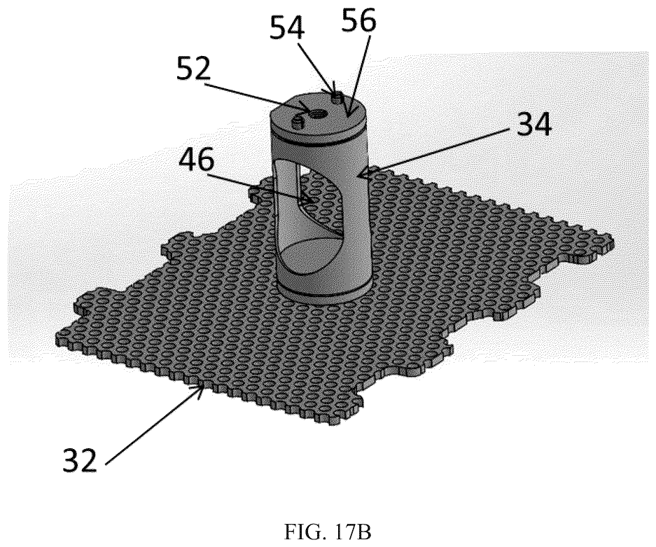

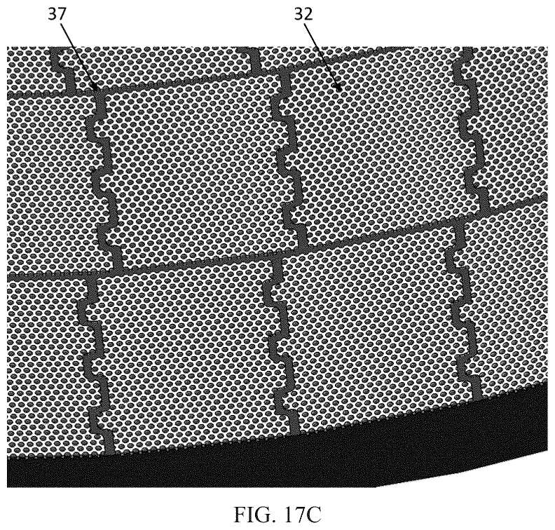

FIGS. 15, 16A, and 17A show different examples of inliner panels 32 with non-linear edges 37. The inliner panel 32 has a pattern of surface features 50, which in the illustrated examples are holes (e.g., circular holes) made (e.g., drilled) into the panel 32. The inliner panel 32 has a straight or linear edge 35 at two opposite ends (e.g., horizontal edges) and a non-linear edge 37 at two opposite ends (e.g., vertical edges). The non-linear edges 37 of the inliner panels 32 can extend in the linear or axial direction of the inliner assembly 100 (e.g., in the direction of the centerline CL), and inliner panels 32 can be arranged so that their non-linear edges key into one another (as shown in FIGS. 16B and 17C), for example, while maintaining the particle gap (e.g., gap 36 discussed above). Advantageously, the non-linear edges 37 inhibit (e.g. prevent, arrest) the flow of particles 270 in the direction of the non-linear edge 37. As particles 270 slip during operation of the centrifugal receiver with the modular tile inliner assembly 100, the particles 270 stay stationary in between the inliner panels 32 of the tiles 30 (e.g., on top of the insulation module), the non-linear edge providing obstructions that inhibit (e.g., prevent) the flow of particles 270, thereby inhibiting (e.g., preventing, reducing) wear on those insulation surfaces.

As shown in FIG. 15, the non-linear edge 37 of the inliner panel 32 can have a plurality of V-shaped features or slots that define a tooth-like or serrated edge. As shown in FIG. 16A, the non-linear edge 37 of the inliner panel 32 can have a plurality of wave-like features or slots that define an undulating or wavelike edge. As shown in FIG. 17A, the non-linear edges 37 on the two opposite ends of the inliner panel 32 can have different edge patterns. Specifically, the non-linear edge 37 on one end (e.g., left-side of the inliner panel 32) can include a repeating pattern of a short peak SP disposed adjacent to a long valley LV. The non-linear edge 37 on the other end (e.g., right-side of the inliner panel 32) can include a repeating pattern of a short valley SV disposed adjacent to a long peak LP. The short peak SP can have a shorter length than the long valley LV. The short peak SP can have a shorter length than the long peak LP. The short valley SV can have a shorter length than the long valley LV. The short peaks SP and the long peaks LP can be formed as protrusions extending from the edges of the inliner panel 32. The short peaks SP and the long peaks LP can have a substantially trapezoidal shape with rounded edges. The long valleys LV can be formed by the negative space between short peaks SP. The short valleys SV can be formed by the negative space between long peaks LP. The repeating edge patterns can be positioned such that, across the width W of the inliner panel 32, the short peaks SP on one end are aligned with the short valleys SV on the other end, and the long valleys LV on one end are aligned with the long peaks LP on the other end. Accordingly, when multiple inliner tiles 32 of FIGS. 17A-17C are placed adjacent to each other, the short peaks SP of one inliner tile 32 can key into (e.g. interlock with) the corresponding short valleys SV of the adjacent inliner tile 32, and the long valleys LV of the one inliner tile 32 can key into the corresponding long peaks LP of the adjacent inliner tile 32. Compared to the non-linear edge features shown in FIGS. 15-16A, the non-linear edge features of FIG. 17A are larger and less numerous per inliner tile 32. The shape and larger size of the non-linear edge features of FIG. 17A can enable the inliner tiles 32 to be manufactured with larger dimensional tolerances, thereby reducing the manufacturing cost. Additionally, the size and shape of the non-linear edge features of FIG. 17A can increase the tolerances for misalignment of adjacent inliner tiles 32.

FIG. 17B depicts a bottom perspective view of the inliner tile 32 of FIG. 17A with an attached spacer 34. As shown in FIG. 17B, in some embodiments, the spacer 34 can be cylindrically shaped. The spacer 34 can include an oval shaped aperture 46 extending therethrough. The spacer 34 can be substantially hollow. In some embodiments, the spacer 34 can include a tapped center hole 52. A rod can extend from the shell 10, through the tapped center hole, and to the inliner panel 32 to secure the inliner panel 32 and the spacer 34 to the shell 10. In some embodiments, the spacer 34 can include a plurality of pins 54 disposed on a distal surface 56 of the spacer 34. The pins 54 can be disposed radially outward from the tapped center hole 52. As shown in FIG. 17B, the tapped center hole 52 and the two pins 54 can be aligned along the same line. In some embodiments, the spacer 34 can include zero, one, two, or more pins 54. The pins 54 can be dimensioned to fit into corresponding holes or sockets formed into the shell 10 (not shown). The pins 54 and corresponding sockets in the shell 10 can enable the inliner tile 30 to be properly positioned on the shell 10 and inhibit (e.g., prevent) rotation of the inliner tile 30.

FIG. 17C shows a plurality of inliner tiles 32 of FIG. 17A adjacent each other so that their non-linear edges 37 are keyed together. As discussed above, such arrangement of the non-linear edges 37 advantageously provides an obstruction that inhibits (e.g., prevents) the flow of particles 270 in the direction of the non-linear edges 37, thereby inhibiting (e.g., preventing, reducing) wear on insulation surfaces in the gap between the non-linear edges 37. As shown in FIG. 17C, including asymmetrical non-linear edge patterns on opposing ends of the inliner tiles 32 can allow for a substantially consistent gap size to be maintained between the non-linear edges 37 of adjacent inliner tiles 32.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects and advantages of the present invention, to which various changes and modifications can be made without departing from the spirit and scope of the present invention. Moreover, the devices described herein need not feature all of the objects, advantages, features and aspects discussed above. Thus, for example, those of skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of embodiments may be made and still fall within the scope of the invention. Accordingly, it should be understood that various features and aspects of the disclosed embodiments can be combined with or substituted for one another in order to form varying modes of the discussed devices.

What is claimed is:

1. A modular inliner assembly for a centrifugal particle receiver having a rotating shell, the modular inliner assembly comprising:
a plurality of inliner tiles removably coupled to the rotating shell, each of the plurality of inliner tiles comprising:
an inliner panel having a top surface extending substantially parallel to the rotating shell; and
a spacer extending from the inliner panel to the rotating shell, wherein the spacer is configured to space the inliner panel from the rotating shell, wherein the spacer is configured to couple the inliner panel to the rotating shell; and
an insulation module disposed between the inliner panels and the rotating shell, wherein the insulation module is configured to inhibit heat transfer from the inliner panels to the rotating shell, wherein the plurality of inliner tiles are spaced from each other by one or more gaps.

2. The modular inliner assembly of claim 1, further comprising a protection module disposed between the inliner panels and the insulation module, wherein the protection module is configured to span across the one or more gaps and provide wear protection to the insulation module.

3. The modular inliner assembly of claim 2, wherein the protection module comprises at least one of a metal foil, a metal mesh, or a ceramic cloth.

4. The modular inliner assembly of claim 1, wherein each of the plurality of inliner panels has a width between about 100 mm and about 300 mm, and the insulation module has a thickness of about 100 mm.

5. The modular inliner assembly of claim 1, wherein the insulation module comprises:
a first insulation module disposed adjacent to the rotating shell; and
a second insulation module disposed adjacent to the first insulation module, wherein the second insulation module is made from a different material than the first insulation module.

6. The modular inliner assembly of claim 1, wherein the insulation module comprises an elastic insulation material.

7. The modular inliner assembly of claim 1, wherein each of the plurality of inliner panels comprises angled sides configured to prevent particles from becoming jammed between adjacent inliner panels.

8. The modular inliner assembly of claim 1, wherein the one or more gaps are configured to allow thermal expansion of the plurality of inliner panels.

9. The modular inliner assembly of claim 8, wherein the gap has a minimum width of about five particle diameters after the plurality of inliner panels have thermally expanded.

10. The modular inliner assembly of claim 1, wherein each of the plurality of inliner tiles further comprises a spring spacer extending between and connecting adjacent inliner panels, wherein the spring spacer is configured to cover the one or more gaps between adjacent inliner panels, wherein the spring spacer forms a recessed channel extending between adjacent inliner panels.

11. The modular inliner assembly of claim 1, wherein each of the plurality of inliner tiles further comprises a shelf extending between adjacent inliner panels, wherein the shelf is configured to cover the one or more gaps between adjacent inliner panels, wherein the shelf forms a recessed channel extending between adjacent inliner panels.

12. The modular inliner assembly of claim 11, wherein the shelf is spaced by a shelf gap from an underside of an adjacent inliner tile, wherein the shelf gap is configured to allow the shelf to slide relative to the adjacent inliner panel during thermal expansion of the plurality of inliner tiles.

13. The modular inliner assembly of claim 12, wherein each of the plurality of inliner tiles further comprises a roller disposed between the shelf and the underside of the adjacent inliner tile.

14. The modular inliner assembly of claim 11, wherein the shelf is mechanically fastened to an adjacent inliner panel.

15. The modular inliner assembly of claim 1, wherein the plurality of inliner tiles extend circumferentially around the rotating shell such that the top surfaces of each of the plurality of inliner tiles collectively form a substantially annular surface that is concentric with the rotating shell.

16. An inliner tile for a centrifugal particle receiver having a rotating shell, the inliner tile comprising:
an inliner panel having a top surface extending substantially parallel to the rotating shell, wherein the top surface comprises a plurality of recessed slots configured to retain particles on the top surface of the inliner panel or a plurality of protrusions configured to retain particles on the top surface of the inliner panel; and
a spacer extending from the inliner panel to the rotating shell, wherein the spacer is configured to space the inliner panel from the rotating shell, wherein the spacer is configured to couple the inliner panel to the rotating shell.

17. The inliner tile of claim 16, wherein each of the plurality of recessed slots has a size of about five to seven times a particle diameter and a depth of about one to times the particle diameter.

18. An inliner tile for a centrifugal particle receiver having a rotating shell, the inliner tile comprising:
an inliner panel comprising:
a top surface extending substantially parallel to the rotating shell; and
two opposite ends extending in a substantially axial direction of the rotating shell, wherein each of the two opposite ends comprises a non-linear edge configured to key into a corresponding non-linear edge of an adjacent inliner panel; and
a spacer extending from the inliner panel to the rotating shell, wherein the spacer is configured to space the inliner panel from the rotating shell, wherein the spacer is configured to couple the inliner panel to the rotating shell.

19. The inliner tile of claim 18, wherein a substantially consistent gap is maintained between the non-linear edge of the inliner tile and the non-linear edge of the adjacent inliner tile.

20. The inliner tile of claim 18, wherein the non-linear edges are formed by a plurality of V-shaped features to define a tooth-like edge.

21. The inliner tile of claim 18, wherein the non-linear edges are formed by a plurality of wave-like features to define a wave-like edge.

22. The inliner tile of claim 18, wherein one of the two opposite ends comprises a non-linear edge formed by a repeating pattern of a short peak disposed adjacent to a long valley, wherein the other one of the two opposite ends comprises a non-linear edge formed by a repeating pattern of a short valley disposed adjacent to a long peak, wherein the short peak is configured to key into a corresponding short valley of the adjacent inliner tile and the long valley is configured to key into a corresponding long peak of the adjacent inliner tile such that a substantially consistent gap is maintained between the inliner tile and the adjacent inliner tile.
